(19) United States
(12) Patent Application Publication
(10) Pub. No.: US 2021/0379485 A1
(43) Pub. Date: Dec. 9, 2021

(54) JUDGMENT ABILITY CALCULATION APPARATUS

(71) Applicant: Toyota Jidosha Kabushiki Kaisha, Toyota-shi Aichi-ken (JP)

(72) Inventors: Yasuo Katsuhara, Susono-shi (JP); Mirai Shimoyama, Susono-shi (JP); Hirotaka Kaji, Hadano-shi (JP); Hirokazu Kikuchi, Hadano-shi (JP); Nobuki Hayashi, Nisshin-shi (JP); Hiroki Ashizawa, Toyota-shi (JP); Tetsuro Sakaguchi, Toyota-shi (JP)

(73) Assignee: Toyota Jidosha Kabushiki Kaisha, Toyota-shi Aichi-ken (JP)

(21) Appl. No.: 17/208,324

(22) Filed: Apr. 30, 2021

(30) Foreign Application Priority Data
Mar. 25, 2020 (JP) 2020-054226

(51) Int. Cl. A63F 13/212; G06F 3/01; A63F 13/67

(52) U.S. Cl. CPC A63F 13/212; A63F 13/67; G06F 3/015

(57) ABSTRACT

A judgment ability calculation apparatus calculates a judgment ability of a player of a video game. The judgment ability calculation apparatus includes: a biological information obtainer configured to obtain biological information relating to the player in linkage with time information; a first calculator configured to calculate a time change in an internal state of the player on the basis of the biological information; an extractor configured to extract an event of attention in linkage with time information; and a second calculator configured to extract an internal state of a predetermined period including a timing at which the event of attention occurs from the time change in the internal state on the basis of the time information linked with the event of attention, the second calculator being configured to calculate the judgment ability of the player from the extracted internal state.

### CROSS-REFERENCE TO RELATED APPLICATIONS

This application is based upon and claims the benefit of priority of the prior Japanese Patent Application No. 2020-054226, filed on Mar. 25, 2020, the entire contents of which are incorporated herein by reference.

### BACKGROUND

### 1. Technical Field

Embodiments of the present disclosure relate to a judgment ability calculation apparatus that is configured to calculate judgment ability of a player of a video game.

### 2. Description of the Related Art

For example, there is proposed a technology/technique in which a characteristic amount indicating heart rate variability of a user during work and information about an information processing ability during work are stored in a preliminary database in association with each other on the basis of time, and in which the information processing capability of the user is estimated by using the preliminary database (refer to Japanese Patent Application Laid Open No. 2016-137138 (Patent Literature 1)).

“Electronic Sports (e-sports),” which captures a competition using video games as a sporting event, is gaining momentum around the world. In e-sports, for example, not only the evaluation of a processing ability based on the performance of a video game but also an ability to judge a point to be concentrated is an evaluation index of a player. In the technology/technique disclosed in the Patent Document 1 described above, there is such a technical problem that it is hardly possible to evaluate the judgment ability of a player.

### SUMMARY

In view of the problem described above, it is therefore an object of embodiments of the present disclosure to provide a judgment ability calculation apparatus that is configured to evaluate the judgment ability of a player of a video game.

The above object of embodiments of the present disclosure can be achieved by a judgment ability calculation apparatus configured to calculate a judgment ability of a player of a video game, the judgment ability calculation apparatus provided with: a biological information obtainer configured to obtain biological information relating to the player in linkage with time information; a first calculator configured to calculate a time change in an internal state of the player on the basis of the biological information; an extractor configured to extract an event of attention, which is a notable event out of events that occur during the progress of the video game, in linkage with time information; and a second calculator configured to extract an internal state of a predetermined period including a timing at which the event of attention occurs from the time change in the internal state on the basis of the time information linked with the event of attention, the second calculator being configured to calculate the judgment ability of the player from the extracted internal state.

### BRIEF DESCRIPTION OF THE DRAWINGS

FIG. 1 is a block diagram illustrating a configuration of a judgment ability calculation apparatus according to an embodiment.

### DETAILED DESCRIPTION OF THE EMBODIMENT

A judgment ability calculation apparatus according to an embodiment will be described. The judgment ability calculation apparatus according to the embodiment calculates a judgment ability of a player of a video game.

When the player shows a good performance of the video game (e.g., a score in the game, etc.), the following evaluation is possible; namely, the player may advance the game well, that is, the player has an excellent information processing ability. For example, in e-sports where game development may be likely greatly changed by the result of a momentary judgment, not only the information processing ability but also the judgement ability of the player is important as an evaluation index.

Therefore, in order to calculate the judgment ability of the player, the judgment ability calculation apparatus includes a biological information obtainer, a first calculator, an extractor, and a second calculator.

The biological information obtainer obtains biological information relating to the player in association with time information. The biological information may include data that reflect the response of an autonomous nervous system, such as, for example, heartbeat, pulse, respiration, blink, line of sight, electroencephalogram (EEG), voice, and body movement. The biological information may be may be obtained, for example, by a wearable sensor worn by the player, or by performing image processing on an image of the player.

The first calculator calculates a time change in an internal state of the player on the basis of the biological information. An example of the “internal state” includes concentration, tension, relaxation or the like. The first calculator may calculate the time change in the internal state by calculating an activity degree of each of sympathetic and parasympathetic nerves, for example, on the basis of the biological information. At this time, when the activity degree of the sympathetic nerve is superior to the activity degree of the parasympathetic nerve, for example, the first calculator may determine that the internal state is concentration, tension or the like, and when the activity degree of the parasympathetic nerve is superior to the activity degree of the sympathetic nerve, for example, the first calculator may determine that it is relaxation or the like. Incidentally, the activity degree of each of the sympathetic and parasympathetic nerves may be calculated, for example, on the basis of fluctuation/variance in heartbeat, inspiratory phase time, pause time of respiration or the like.

The extractor extracts an event of attention, which is a notable event out of events that occur during the progress of the video game, in linkage with the time information. An example of the event of attention includes an unavoidable event on the progress of the game (e.g., passing a specific point, defeating a specific character, etc.) and an event that may affect the development of the game (e.g., causing a relatively severe damage to an opponent character, etc.). Incidentally, the event of attention may be determined before a player who is a calculation target of the judgment ability plays the video game, or may be determined after the player finishes playing the video game.

The extractor may extract the event of attention in linkage with the time information, for example, by detecting the setting of a predetermined flag, or by detecting a relatively significant change in the score, on the basis of game data relating to the video game.

The second calculator extracts an internal state of a predetermined period including a timing at which the event of attention occurs from the time change in the internal state of the player on the basis of the time information linked with the event of attention, and calculates the judgment ability of the player from the extracted internal state. Since the event of attention is linked with the time information, the second calculator is allowed to specify the timing at which the event of attention occurs. The second calculator extracts the internal state of the predetermined period including the timing at which the event of attention occurs. Thus, the internal state of the player when the event of attention occurs is extracted.

During the progress of the video game, there are an event that is intended by the player and an event that is not intended by the player (i.e., by chance). If an event of attention occurs when the concentration is relatively high as the internal state of the player, it can be considered that the event of attention occurs by the intention (in other words, by judgment) of the player. On the other hand, if an event of attention occurs when the concentration of the players is relatively low, it can be considered that the event of attention occurs regardless of the intention of the player. Therefore, for example, the second calculator may calculate the ratio of a time during which the player concentrates, in the predetermined period, as the judgment ability of the player.

As described above, according to the judgment ability calculation apparatus, it is possible to calculate the judgment ability of the player of the video game.

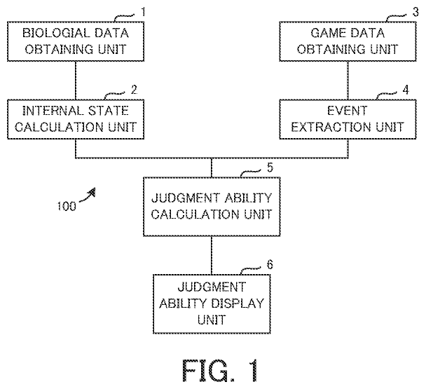

A judgment ability calculation apparatus 100 as a specific example of the judgment ability calculation apparatus according to the embodiment will be described with reference to FIG. 1. In FIG. 1, the judgment ability calculation apparatus 100 is provided with a biological data obtaining unit 1, an internal state calculation unit 2, a game data obtaining unit 3, an event extraction unit 4, a judgment ability calculation unit 5, and a judgment ability display unit 6.

The biological data obtaining unit 1 obtains biological information including data that reflect the response of an autonomous nervous system, such as, for example, heartbeat, pulse, respiration, blink, line of sight, electroencephalogram (EEG), voice, and body motion, in linkage with time information, for example, from the output of a wearable sensor worn by a player. It should be noted that the biological information does not need to include all of the heartbeat, the pulse, the respiration, the blink, the line of sight, the EEG, the voice, the body movement, and the like, for example, and it is sufficient to include at least one of those.

The internal state calculation unit 2 extracts the characteristics of the biological information described above and calculates the activity degree of each of the sympathetic and parasympathetic nerves. For example, when a time change in respiration of the player is obtained as the biological information, the internal state calculation unit 2 may focus on the pause time of the respiration. In this case, when the pause time is less than a reference value, the internal state calculation unit 2 may make the activity degree of the sympathetic nerve superior to the activity degree of the parasympathetic nerve. At this time, the internal state calculation unit 2 may use, for example, “concentration” “tension”, “stress” or the like, to state that the activity degree of the sympathetic nerve is superior to the activity degree of the parasympathetic nerve. That is, the internal state calculation unit 2 compares the activity degree of the sympathetic nerve with the activity degree of the parasympathetic nerve to estimate the internal state of the player.

When it is determined which is superior between the activity degree of the sympathetic nerve and the activity degree of the parasympathetic nerve, for example, if the activity degree of the sympathetic nerve is greater than the activity degree of the parasympathetic nerve by a first reference value or higher, then, it may be determined that the activity degree of the sympathetic nerve is superior. Similarly, if the activity degree of the parasympathetic nerve is greater than the activity degree of the sympathetic nerve by a second reference value or higher, then, it may be determined that the activity degree of the parasympathetic nerve is superior. The first reference value and the second reference value may be set for each player and/or for each game, or may be a fixed value. Moreover, the first reference value and the second reference value may be the same.

The game data obtaining unit 3 obtains game data including, for example, a score in a game, a position of a player character, an event that occurs during the progress of the game, and the like. Here, the game data may be obtained, for example, from API (Application Program Interface) or the like. Alternatively, the game data may be obtained, for example, by performing image processing on an image corresponding to a game screen.

The event extraction unit 4 extracts the event that occurs during the progress of the game, from the game data, in linkage with time information. The event extraction unit 4 may use an event included in the game data. In particular, the event extraction unit 4 extracts an event of attention, which is a notable event out of events that occur during the progress of the game. Incidentally, the event extraction unit 4 may extract only the event of attention, or may also extract another event in addition to the event of attention.

The judgment ability calculation unit 5 associates the internal state of the player estimated by the internal state calculation unit 2 with the event of attention extracted by the event extraction unit 4 on the basis of the time information. The judgment ability calculation unit 5 calculates, from a result of the association, the ratio of a time during which the player concentrates (in other words, a time during which the activity degree of the sympathetic nerve is superior to the activity degree of the parasympathetic nerve) in a predetermined period including a timing at which the event of attention occurs, as the judgment ability of the player. For example, if the predetermined period is 2 minutes and the time during which the player concentrates is 1 minute 30 seconds, the judgment ability calculation unit 5 calculates that the judgment ability of the player is 75%. The method of calculating the judgment ability is an example and is not limited to the above example.

The judgment ability display unit 6 displays the calculated judgment ability. A display aspect of the judgment ability may be, for example, a pie chart, a percentage or the like.

(Technical Effects)

According to the judgment ability calculation apparatus 100, it is possible to calculate the judgment ability of a player of a video game. For example, when a plurality of players form a team, a supervisor or a coach of the team may determine a member, with reference to the judgment ability calculated by the judgment ability calculation apparatus 100. When the judgment ability calculation apparatus 100 is configured to output a time change in the judgment ability of the player together with a timing at which an event of attention occurs, for example, the player may be able to know when to focus and which concentration was unnecessary by referring to the output of the judgment ability calculation apparatus 100, and it can be utilized for training of a video game. In this case, an audience may be able to know, for example, in what scene a player who enters an event of e-sports increases the concentration, and it can be utilized to improve the skill of the audience. For example, when the game progress of the video game is distributed via a network or the like, a commentator or the like may be able to enrich a running commentary with reference to the judgment ability.

### MODIFIED EXAMPLE

The judgment ability calculation unit 5 may calculate, as the judgment ability, a value that is obtained by subtracting the ratio of a time during which a player concentrates in a second predetermined time including a timing at which an event other than an event of attention occurs, from the ratio of a time during which the player concentrates in a first predetermined period including a timing at which the event of attention occurs.

Aspects of embodiments of the present disclosure derived from the embodiment and modified example described above will be described below.

A judgment ability calculation apparatus according to an aspect of embodiments of the present disclosure is a judgment ability calculation apparatus configured to calculate a judgment ability of a player of a video game, the judgment ability calculation apparatus provided with: a biological information obtainer configured to obtain biological information relating to the player in linkage with time information; a first calculator configured to calculate a time change in an internal state of the player on the basis of the biological information; an extractor configured to extract an event of attention, which is a notable event out of events that occur during the progress of the video game, in linkage with time information; and a second calculator configured to extract an internal state of a predetermined period including a timing at which the event of attention occurs from the time change in the internal state on the basis of the time information linked with the event of attention, the second calculator being configured to calculate the judgment ability of the player from the extracted internal state.

In the above-described embodiment, the biological data obtaining unit 1 corresponds to an example of the biological information obtainer, the internal state calculation unit 2 corresponds to an example of the first calculator, the event extraction unit 4 corresponds to an example of the extractor, and the judgment ability calculation unit 5 corresponds to an example of the second calculator.

The present disclosure may be embodied in other specific forms without departing from the spirit thereof. The present embodiments and examples are therefore to be considered in all respects as illustrative and not restrictive, the scope of the disclosure being indicated by the appended claims rather than by the foregoing description and all changes which come in the meaning and range of equivalency of the claims are therefore intended to be embraced therein.

What is claimed is:

1. A judgment ability calculation apparatus configured to calculate a judgment ability of a player of a video game, the judgment ability calculation apparatus comprising:
a biological information obtainer configured to obtain biological information relating to the player in linkage with time information;
a first calculator configured to calculate a time change in an internal state of the player on the basis of the biological information;
an extractor configured to extract an event of attention, which is a notable event out of events that occur during the progress of the video game, in linkage with time information; and
a second calculator configured to extract an internal state of a predetermined period including a timing at which the event of attention occurs from the time change in the internal state on the basis of the time information linked with the event of attention, the second calculator being configured to calculate the judgment ability of the player from the extracted internal state.
